(19) United States
(12) Patent Application Publication
(10) Pub. No.: US 2023/0302393 A1
(43) Pub. Date: Sep. 28, 2023

(54) SYSTEM AND METHOD FOR DIRECT AIR CAPTURE OF CARBON DIOXIDE UTILIZING A MICROWAVE DESORPTION TECHNIQUE

(71) Applicant: Xiwang Qi, Scottsdale, AZ (US)

(72) Inventor: Xiwang Qi, Scottsdale, AZ (US)

(21) Appl. No.: 18/186,365

(22) Filed: Mar. 20, 2023

Related U.S. Application Data
(60) Provisional application No. 63/323,887, filed on Mar. 25, 2022.

(51) Int. Cl. B01D 53/00; B01D 53/04; B01J 20/22; B01J 20/32; B01J 20/28

(52) U.S. Cl. CPC B01D 53/007; B01D 53/0446; B01J 20/22; B01J 20/3204; B01J 20/3248; B01J 20/28045; B01J 20/28016; B01D 2253/25; B01D 2253/3425; B01D 2259/806; B01D 2257/504

(57) ABSTRACT

A direct air capture of CO2 system and method including a chamber defining a microwave cavity, a microwave heating unit coupled to the chamber in electromagnetic communication, and a sorbent structure carried within the chamber. The sorbent structure includes one or more porous support structures each having a plurality of pores and channels formed therethrough providing a large area of surfaces coated by nanoparticles of CO2 adsorbent material. A motor fan creates an air flow through the chamber and the sorbent structure carried therein. CO2 in the air is adsorbed by the CO2 adsorbent material. The microwave heating unit heats the CO2 adsorbent material to desorb the CO2 for further sequestration or value-added utilization.

### FILED OF THE INVENTION

The present invention generally relates to solid sorbents systems for direct carbon dioxide (CO2) capture from air. More particularly, the present invention relates to systems and methods for driving the capture and release of CO2 from solid sorbents.

### BACKGROUND OF THE INVENTION

Increasing concentration of CO2 in the atmosphere is currently worrying many people and governments. Climate change is believed to be driven by this increase which is attributed to human-induced emissions. It is generally accepted that a reduction in the concentration, or at least a reduction in the increase of CO2 in the atmosphere is desired. The International Panel on Climate Change (IPCC) estimates that approximately 10 gigatons of net CO2 removal per year by 2050 is needed to keep global temperatures from rising 1.5-2 C to avoid the worst effects of climate change. It is commonly agreed that emissions reduction alone is not enough, and that society needs to employ technology to collectively solve the imminent climate change problem.

Currently, carbon capture technologies are used to prevent the release of carbon dioxide (CO2) into the atmosphere. In the most commonly used arrangement today, a chemical is used to capture CO2. This chemical is placed in or near a source of CO2. The captured CO2 can then be disposed of or used as desired. The full process is called carbon capture, utilization, and storage (CCUS). This approach is used at stationary sources of CO2 such as power plants, ethanol production plants, or other industrial facilities where high concentrations of CO2 are being released into the atmosphere. These technologies are typically used for flue gas CO2 emission reduction. The concentration of CO2 in flue gas emissions varies, but is usually at high concentrations (10-20% CO2). Examples includes liquid solvent scrubbing and base chemical reactions using concentrated NaOH or Na2CO3 solutions. Because of the high costs associated with aqueous solution approaches, in recent years solid sorbent approaches have received a lot of attention due to the potential for low energy input and low operating costs.

Another technology is direct air capture (DAC). In direct air capture, CO2 is captured from the atmosphere where the CO2 concentration is approximately 400 ppm, substantially less than in flue gasses. In many DAC technologies, air is forced over a chemical that can bond CO2. DAC technologies and CCUS may use the same chemicals, but must be optimized for the different CO2 concentrations. The use of solid sorbents is becoming more prevalent in DAC technologies. A single unit with a solid sorbent is used, where adsorption and desorption (regeneration) of CO2 happen one after another in a repeating cycle. After saturation, the solid sorbent is regenerated by thermal heating of the system to a certain temperature, mostly above 100 C, to release the CO2 from the sorbent. The system is then cooled down to return the solid sorbent to ambient conditions to start another cycle. The thermal energy requirement for heating the system in the regeneration process accounts for roughly 80% of the operation energy cost in the state of the art direct air capture process, making the cost of per ton CO2 captured prohibitively high (>$600/ton), which prevents economical large-scale implementation. Not only does the heat generation required for regeneration take large amounts of energy, bringing the system and the solid sorbent used therein back to ambient temperatures can also take large amounts of time and/or energy. Therefore, there is an urgent need to develop a new direct air capture technology which can capture low concentration CO2 (400 ppm) at scale and at an affordable cost, ideally below $100 for per ton CO2 captured.

It would be highly advantageous, therefore, to remedy the foregoing and other deficiencies inherent in the prior art.

An object of the present invention is to provide a solid sorbent material system with energy-efficient and fast desorption of CO2 from saturated sorbents.

### SUMMARY OF THE INVENTION

Briefly to achieve the desired objects and advantages of the instant invention in accordance with a preferred embodiment thereof, provided is a direct air capture of CO2 system. The direct air capture system includes a chamber defining a microwave cavity and having an upstream end and an opposing downstream end. A microwave heating unit is coupled to the chamber in electromagnetic communication with the microwave cavity. A sorbent structure is carried within and fills the chamber. The sorbent structure includes one or more porous support structures each carrying CO2 adsorbent material. The one or more porous support structures have a plurality of pores and channels formed therethrough providing a large area of surfaces coated by the CO2 adsorbent material. A motor fan is coupled to the downstream end of the chamber to create an air flow from the upstream end to the downstream end and draw air through the chamber and the sorbent structure carried therein.

In another aspect, a method of direct air capture of CO2 from air is provided. The steps of the method include providing a chamber defining a microwave cavity and having an upstream end and an opposing downstream end, providing a microwave heating unit coupled to the chamber in electromagnetic communication with the microwave cavity, and providing a sorbent structure carried within and filling the chamber, the sorbent structure including one or more porous support structures each carrying CO2 adsorbent material, the one or more porous support structures having a plurality of pores and channels formed therethrough providing a large area of surfaces coated by the CO2 adsorbent material. A motor fan is provided and coupled to the downstream end of the chamber to create an air flow from the upstream end to the downstream end and draw air through the chamber and the sorbent structure carried therein. The motor fan is turned to an on configuration to create a flow of ambient air through the chamber and the sorbent structure carried therein. The ambient air is drawn into the upstream end of the chamber and passes through the pores and channels of the porous support structure with the CO₂ within the air contacting and being adsorbed by the CO2 adsorbent material. The CO2 depleted air is passed out through the downstream end. The airflow is stopped from entering the upstream end of the chamber when the adsorption of CO2 by the CO2 adsorbent material has reached a desired level. The microwave heating unit is turned to an on configuration to heat the CO2 adsorbent material with adsorbed CO2 until a desorption temperature is reached, releasing the CO2 out the downstream end and regenerating the CO2 adsorbent material. The microwave heating unit is then turned to an off configuration once desorption of the CO2 adsorbent material is complete. Airflow into the upstream end is reestablished and the process is repeated.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a simplified schematic view of a direct air capture of CO2 system according to the present invention;

FIG. 2 is a sectional schematic view of an example of a sorbent structure in pellet form;

FIG. 3 is an isometric schematic view of an example of the sorbent structure in a honeycomb structure form; and

FIG. 4 is an enlarged partial sectional view of the honeycomb structure.

### DETAILED DESCRIPTION

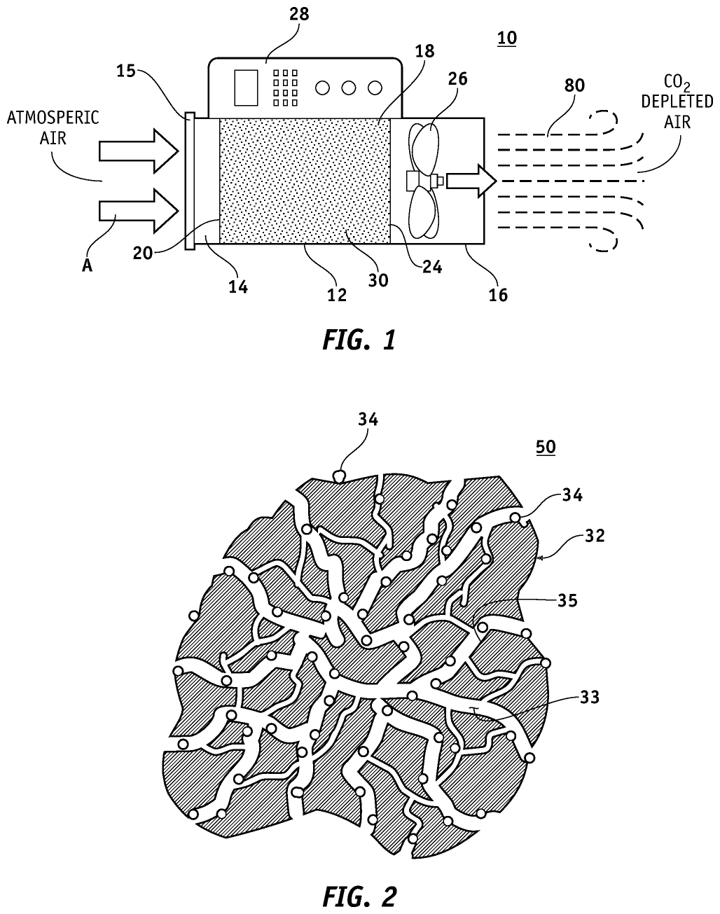

Turning now to the drawings in which like reference characters indicate corresponding elements throughout the several views, attention is directed to FIG. 1 which illustrates a direct air capture of CO2 system generally designated 10. Direct air capture (DAC) is a CO2 capture approach which removes CO2 from the atmosphere (ambient air). Direct air capture CO2 system 10 can operate to remove CO2 from ambient air which typically has a low CO2 concentration of approximately 400 ppm. The DAC system 10 includes a duct 12 defining an airflow path indicated by arrows A. Duct 12 is generally tubular and has an inlet end 14 and an outlet end 16. Inlet end 14 is selectively closable by a shutter assembly 15 movable between an open position, allowing air to enter inlet end 14, and a closed position, preventing air from entering inlet end 14. Atmospheric air moving along airflow path A enters duct 12 at inlet end 14 with shutter assembly 15 in the open position and exits duct 12 at outlet end 16. A chamber 18 is carried by duct 12 intermediate inlet end 14 and outlet end 16. Atmospheric air flows from inlet end 14 through an upstream end 20 of chamber 18 and out a downstream end 24 to outlet end 16 of duct 12. To create airflow along airflow path A and draw atmospheric air through chamber 18, a motor fan 26 operable between an on and an off configuration is carried by duct 12 proximate outlet end 16 and adjacent downstream end 24 of chamber 18. Motor fan 26 in the on configuration draws air into duct 12 and through chamber 18 along airflow path A. A microwave heating unit 28 operable between an on and an off configuration is coupled to chamber 18 in electromagnetic communication. Chamber 18 is fabricated of metal and defines a microwave cavity.

Still referring to FIG. 1, with additional reference to FIGS. 2-4, a sorbent structure 30 is carried within and filling chamber 18 from upstream end 20 to downstream end 24. Sorbent structure 30 includes one or more porous support structures 32 each carrying adsorbent material 34. Porous support structures 32 can be used in the physical form of pellets, granules, or a honeycomb structure and the like. Each of these can be used to fill chamber 18 through which air flows. The porous nature of these structures allows the flow of air therethrough while ensuring contact with adsorbent materials 34. Porous support structures 32 can also include structure strengthening materials chosen from alumina, silica, magnesium oxide, cerium oxide, zeolite, cordierite or combinations thereof. The structure strengthening materials employed are generally transparent to microwave energy due to their low dielectric constant and loss factor. Thus, the thermal mass for a desorption heating process is minimized.

Referring specifically to FIG. 2, a pellet 50 is illustrated in a simplified cross-sectional schematic. Pellet 50 includes porous support structure 32 having a multitude of pores and channels 33 formed therethrough providing a large area of surfaces 35. Porous support structure 32 consists of microwave absorptive materials, chosen from activated carbon, silicon carbide or both. A large number of pellets 50 are used to fill chamber 18, cooperatively forming sorbent structure 30. Nanoparticles of adsorbent material 34 coat surfaces 35 of each pellet 50 used to form sorbent structure 30. CO2 adsorbent materials 34 are hybrid amines, including at least two amine or polyamine components chosen from the list of monoethanolamine, methyldiethanolamine, diethanolamine, ethylenediamine, aminomethyl propanol, diisopropylamine, triethylenetetramine, diethylenetriamine, triethanolamine, tetraethylenepentamine, piperazine, as well as amino group containing polymers including polyethyleneimine, polyacrylamide and chitosan.

An example of a sorbent structure including nanostructured CO2 adsorbent material coated on a porous support structure was synthesized by coating hybrid amines consisting of monoethanolamine, diethanolamine, diethylenetriamine and polyethyleneimine (Dow Chemicals, Michigan) on activated carbon support. 20 g above prepared sorbent was tested for direct CO2 capture from air in an 80 L closed air chamber with circulation fan. The CO2 concentration was reduced to below 200 ppm in 4.5 minutes from initial 400 ppm. 10 g of this same sorbent structure was placed inside a 700 W microwave oven heating chamber. After heating for 80 seconds under 10% microwave power input, the sample rose from room temperature to 75 C, which is the CO2 desorption temperature of the current invention. 10 g of sorbent structure with the addition of a composite of structure strengthening materials consisting of carbon, alumina and zeolite was placed inside a 700 W microwave oven heating chamber. After heating for 105 seconds under 10% microwave power input, the sample rose from room temperature to 75 C, which is the CO2 desorption temperature of the current invention. By way of comparison, 10 g of diethanolamine alone in a beaker was placed inside a 700 W microwave oven heating chamber. After heating for 80 seconds under 10% microwave power input, the sample rose only to 37 C from room temperature. This is insufficient for desorption of the diethanolamine.

As is well known and therefore not illustrated specifically, microwave heating unit 28 includes a magnetron and a waveguide to direct the microwaves into chamber 18. The magnetron preferably generates microwaves at a frequency of 915 MHz or 2.45 GHz. By taking advantage of invasive microwave dielectric heating phenomenon, the carbon or silicon carbide in porous support structure 32 strongly absorbs microwave energy and subsequently heats the CO2 loaded adsorbent materials 34 to the desired desorption temperature in a very short time without heating chamber 18 or other inert materials in sorbent structure 30. Another advantage of microwave heating in the present desorption process is that the moisture absorbed in sorbent structure 30 during adsorption also absorbs microwave energy which further enhances the desorption heating process.

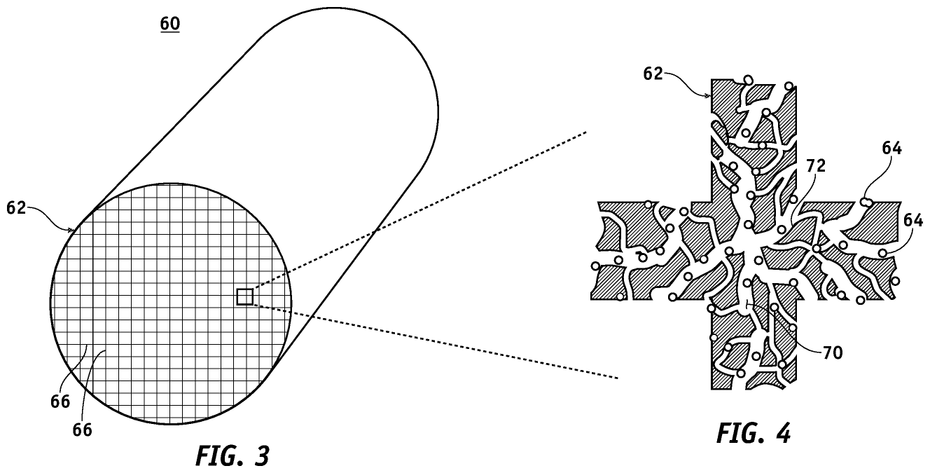

Turning now to FIG. 3, a honeycomb structure 60 is illustrated in an isometric schematic view. Honeycomb structure 60 includes a porous support structure 62 carrying CO2 adsorbent materials 64. One or more honeycomb structures 60 can be used to fill chamber 18, individually or cooperatively forming sorbent structure 30. With additional reference to FIG. 4, porous support structure 62 of honeycomb structure 60 has a plurality of intersecting walls 66. The porous nature of walls 66 and the channels between, allows flow of air therethrough, while ensuring contact with adsorbent materials 64. Porous support structure 62 includes a multitude of pores and channels 70 formed therethrough providing a large area of surfaces 72. Porous support structure 62 consists of microwave absorptive materials, chosen from activated carbon, silicon carbide or both. Nanoparticles of adsorbent material 64 coat the inside of the pores and surfaces 72 of porous support structure 62 taking the form of honeycomb structure 60. CO2 adsorbent materials 64 are hybrid amines, including at least two amine or polyamine components chosen from the list of monoethanolamine, methyldiethanolamine, diethanolamine, ethylenediamine, aminomethyl propanol, diisopropylamine, triethylenetetramine, diethylenetriamine, triethanolamine, tetraethylenepentamine, piperazine, as well as amino group containing polymers including polyethyleneimine, polyacrylamide and chitosan. Honeycomb structure 60 can also include structure strengthening materials chosen from alumina, silica, magnesium oxide, cerium oxide, zeolite, cordierite or combinations thereof. The structure strengthening materials employed are generally transparent to microwave energy due to their low dielectric constant and loss factor. Thus, the thermal mass for the desorption heating process is minimized.

In operation, DAC system 10 repeatedly cycles through an adsorption process and a desorption process. During the adsorption process, ambient air is drawn along airflow path A, down duct 12 and through chamber 18 and sorbent structure 30 by motor fan 26 in the on configuration. As ambient air moves through sorbent structure 30, the CO2 in the air is in close contact with and chemically binds to adsorbent materials 34, 64. After passing through sorbent structure 30, the CO2 depleted air 80 exits outlet end 16, leaving DAC system 10 and enters back into the atmosphere. The adsorption process is completed when adsorbent materials 34, 64 are fully saturated with CO2 or reach a desired adsorption level. In the following desorption process, shutter assembly 15 is moved to the closed position preventing ingress of air into DAC system 10. Microwave heating unit 28 is turned on, which quickly heats adsorbent materials 34, 64 to the desired desorption temperature, at which the adsorbed CO2 is released and blown out of DAC system 10 by motor fan 26. The released CO2 is collected for further sequestration or value-added utilization. Since microwave heating unit 28 selectively and directly heats only the CO2 loaded adsorbent materials 34, 64 and microwave absorptive materials of porous support structure 32, 62 without heating chamber 18 and other balance materials, the energy transfer and utilization efficiency is significantly improved and thus the energy cost is greatly reduced as compared to traditional thermal heating, such as electrical heating tapes and coils, hot gas or steam circulations, etc. Additionally, the heating of less material reduces the time to cool DAC system 10 back to ambient temperatures for the continuation of the adsorption process. Once DAC system 10 has cooled to ambient temperature, adsorbent materials 34, 64 are ready to capture CO2 again. At this point shutter assembly 15 is moved to the open position reestablishing air flow through sorbent structure 30 to continue the cycle.

DAC system 10 provides an efficient and low-cost approach for direct CO2 capture from air. While the primary application of this invention is for direct air capture of CO2, it should be noted that this invention is not limited to direct air capture, it can also be used for spot CO2 emission reductions in places such as power plants, cement and steel manufacturers, as well as transportation and oil and gas industries and the like.

The present invention is described above with reference to illustrative embodiments. Those skilled in the art will recognize that changes and modifications may be made in the described embodiments without departing from the nature and scope of the present invention. Various changes and modifications to the embodiments herein chosen for purposes of illustration will readily occur to those skilled in the art. To the extent that such modifications and variations do not depart from the invention, they are intended to be included within the scope thereof.

1. A direct air capture of CO2 system, comprising:
a chamber defining a microwave cavity and having an upstream end and an opposing downstream end;
a microwave heating unit coupled to the chamber in electromagnetic communication with the microwave cavity;
a sorbent structure carried within and filling the chamber, the sorbent structure including one or more porous support structures each carrying nanoparticles of CO2 adsorbent material, the one or more porous support structures having a plurality of pores and channels formed therethrough providing a large area of surfaces coated by the CO2 adsorbent material; and
a motor fan coupled to the downstream end of the chamber to create an air flow from the upstream end to the downstream end and draw air through the chamber and the sorbent structure carried therein.

2. The direct air capture of CO2 system as claimed in claim 1, wherein the CO2 adsorbent material are hybrid amines, consisting of at least two amine or polyamine components chosen from the list of monoethanolamine, methyldiethanolamine, diethanolamine, ethylenediamine, aminomethyl propanol, diisopropylamine, triethylenetetramine, diethylenetriamine, triethanolamine, tetraethylenepentamine, piperazine, as well as amino group containing polymers including polyethyleneimine, polyacrylamide and chitosan.

3. The direct air capture of CO2 system as claimed in claim 1, wherein the one or more porous support structures include microwave absorptive materials, chosen from activated carbon, silicon carbide or both.

4. The direct air capture of CO2 system as claimed in claim 3, wherein the one or more porous support structures further include structure strengthening materials chosen from alumina, silica, magnesium oxide, cerium oxide, zeolite, cordierite or combinations thereof, which are generally transparent to microwave energy.

5. The direct air capture of CO2 system as claimed in claim 1, further comprising a shutter assembly coupled to the upstream end of the chamber, the shutter assembly movable between an open position allowing air to the upstream end, and a closed position, preventing air from entering the upstream end.

6. The direct air capture of CO2 system as claimed in claim 1, wherein the one or more porous support structures are pellets, granules, or a honeycomb structure.

7. The direct air capture of CO2 system as claimed in claim 1, wherein the microwave heating unit generates microwaves at 915 MHz or 2.45 GHz frequency for selective heating of the CO2 adsorbent material.

8. The direct air capture of CO2 system as claimed in claim 1, further including a duct having an inlet end and an outlet end, the chamber carried within the duct intermediate the inlet end and the outlet end, the motor fan a motor fan carried by the duct proximate the outlet end and adjacent the downstream end of the chamber.

9. A direct air capture of CO2 system, comprising:
a metal chamber defining a microwave cavity and having an upstream end and an opposing downstream end;
a microwave heating unit coupled to the chamber in electromagnetic communication with the microwave cavity;
a sorbent structure carried within and filling the chamber, the sorbent structure including one or more porous support structures each carrying nanoparticles of CO2 adsorbent material, the one or more porous support structures having a plurality of pores and channels formed therethrough providing a large area of surfaces coated by the CO2 adsorbent material;
the CO2 adsorbent material being hybrid amines, consisting of at least two amine or polyamine components chosen from the list of monoethanolamine, methyldiethanolamine, diethanolamine, ethylenediamine, aminomethyl propanol, diisopropylamine, triethylenetetramine, diethylenetriamine, triethanolamine, tetraethylenepentamine, piperazine, as well as amino group containing polymers including polyethyleneimine, polyacrylamide and chitosan;
the porous support structures include microwave absorptive materials, chosen from activated carbon, silicon carbide or both; and
a motor fan coupled to the downstream end of the chamber to create an air flow from the upstream end to the downstream end and draw air through the chamber and the sorbent structure carried therein.

10. The direct air capture of CO2 system as claimed in claim 9, wherein the one or more porous support structures further include structure strengthening materials chosen from alumina, silica, magnesium oxide, cerium oxide, zeolite, cordierite or combinations thereof, which are generally transparent to microwave energy.

11. The direct air capture of CO2 system as claimed in claim 9, further comprising a shutter assembly coupled to the upstream end of the chamber, the shutter assembly movable between an open position allowing air to the upstream end, and a closed position, preventing air from entering the upstream end.

12. The direct air capture of CO2 system as claimed in claim 9, wherein the one or more porous support structures are pellets, granules, or a honeycomb structure.

13. The direct air capture of CO2 system as claimed in claim 9, wherein the microwave heating unit generates microwaves at 915 MHz or 2.45 GHz frequency for selective heating of the CO2 adsorbent material.

14. A method of direct air capture of CO2 comprising the steps of:
providing a chamber defining a microwave cavity and having an upstream end and an opposing downstream end;
providing a microwave heating unit coupled to the chamber in electromagnetic communication with the microwave cavity;
providing a sorbent structure carried within and filling the chamber, the sorbent structure including one or more porous support structures each carrying nanoparticles of CO2 adsorbent material, the one or more porous support structures having a plurality of pores and channels formed therethrough providing a large area of surfaces coated by the CO2 adsorbent material; and
providing a motor fan coupled to the downstream end of the chamber to create an air flow from the upstream end to the downstream end and draw air through the chamber and the sorbent structure carried therein;
turning the motor fan to an on configuration to create a flow of ambient air through the chamber and the sorbent structure carried therein, the ambient air drawn into the upstream end of the chamber and passing through the pores and channels of the porous support structure with the CO2 within the air contacting and being adsorbed by the CO2 adsorbent material, the CO2 depleted air passing out through the downstream end;
stopping the airflow from entering the upstream end of the chamber when the adsorption of CO2 by the CO2 adsorbent material has reached a desired level;
turning the microwave heating unit to an on configuration to heat the CO2 adsorbent material with adsorbed CO2 until the desorption temperature is reached releasing the CO2 out the downstream end and regenerating the CO2 adsorbent material;
turning the microwave heating unit to an off configuration once desorption of the CO2 adsorbent material is complete; and
reestablishing airflow into the upstream end to repeat the process.

15. The method as claimed in claim 14 wherein the step of stopping the airflow from entering the upstream end of the chamber further comprising the steps of:
providing a shutter assembly coupled to the upstream end of the chamber, the shutter assembly movable between an open position allowing air to the upstream end, and a closed position, preventing air from entering the upstream end; and
moving the shutter assembly to the closed position.

16. The method as claimed in claim 15 wherein the step of reestablishing the airflow into the upstream end of the chamber comprising the step of moving the shutter assembly to an open position.

17. The method as claimed in claim 14 wherein the step of providing a sorbent structure including one or more porous support structures includes forming the one or more porous support structures from microwave absorptive materials chosen from a group consisting of activated carbon, silicon carbide or both.

18. The method as claimed in claim 14 wherein the step of providing a sorbent structure including CO2 adsorbent material includes the step of providing nanoparticles of CO2 adsorbent material that are hybrid amines, consisting of at least two amine or polyamine components chosen from the list of monoethanolamine, methyldiethanolamine, diethanolamine, ethylenediamine, aminomethyl propanol, diisopropylamine, triethylenetetramine, diethylenetriamine, triethanolamine, tetraethylenepentamine, piperazine, as well as amino group containing polymers including polyethyleneimine, polyacrylamide and chitosan.

19. The method as claimed in claim 14 wherein the step of providing a sorbent structure further includes providing structure strengthening materials chosen from alumina, silica, magnesium oxide, cerium oxide, zeolite, cordierite or combinations thereof, which are generally transparent to microwave energy.

20. The method as claimed in claim 14 wherein the step of providing one or more porous support structures further includes providing one or more porous support structures having the form of pellets, granules, or honeycomb structures.
